(19) United States
(12) Patent Application Publication
(10) Pub. No.: US 2019/0202307 A1
(43) Pub. Date: Jul. 4, 2019

(54) LIQUID COOLED BATTERY PACK DESIGNS FOR ELECTRIFIED VEHICLES

(71) Applicant: FORD GLOBAL TECHNOLOGIES, LLC, Dearborn, MI (US)

(72) Inventors: Kevin A. Montgomery, Royal Oak, MI (US); Hari Krishna Addanki, Novi, MI (US); Eid Farha, Ypsilanti, MI (US); Michael E. Reibling, Sterling Heights, MI (US); Jeffrey Michael Haag, Dearborn, MI (US); Brock Dunlap, Dearborn, MI (US); Samir Subba, Dearborn, MI (US)

(21) Appl. No.: 15/860,977

(22) Filed: Jan. 3, 2018

(51) Int. Cl. B60L 11/18; H01M 10/613; H01M 10/617; H01M 10/625; H01M 10/6556; H01M 10/6567

(52) U.S. Cl. CPC B60L 11/1874; H01M 10/613; H01M 10/6567; H01M 10/625; H01M 10/6556; H01M 10/617

(57) ABSTRACT

A battery pack includes a heat exchanger plate assembly that includes a plate body, a retention cradle protruding outwardly from the plate body, and a coolant conduit secured to the plate body by the retention device. The coolant conduit may snap into the retention cradle to secure the coolant conduit to the plate body.

### TECHNICAL FIELD

This disclosure relates to electrified vehicle battery packs, and more particularly to liquid cooled battery pack designs that utilize heat exchanger plates for thermally managing the battery packs.

### BACKGROUND

The desire to reduce automotive fuel consumption and emissions is well documented. Therefore, vehicles are being developed that reduce or completely eliminate reliance on internal combustion engines. Electrified vehicles are currently being developed for this purpose. In general, electrified vehicles differ from conventional motor vehicles because they are selectively driven by one or more battery powered electric machines. Conventional motor vehicles, by contrast, rely exclusively on the internal combustion engine to propel the vehicle.

A high voltage battery pack typically powers the electric machines and other electrical loads of the electrified vehicle. The battery pack includes a plurality of battery cells that store energy for powering these electrical loads. The battery cells generate heat as they are charged and discharged. This heat should be dissipated in order to achieve a desired level of performance.

### SUMMARY

A battery pack according to an exemplary aspect of the present disclosure includes, among other things, a heat exchanger plate assembly including a plate body, a retention cradle protruding outwardly from the plate body, and a coolant conduit secured to the plate body by the retention device.

In a further non-limiting embodiment of the foregoing battery pack, the plate body is an extruded, aluminum plate body.

In a further non-limiting embodiment of either of the foregoing battery packs, the coolant conduit is a flexible tube.

In a further non-limiting embodiment of any of the foregoing battery packs, the heat exchanger plate assembly is a base of a battery assembly of the battery pack.

In a further non-limiting embodiment of any of the foregoing battery packs, the heat exchanger plate assembly is a side wall of a battery assembly of the battery pack.

In a further non-limiting embodiment of any of the foregoing battery packs, the heat exchanger plate assembly establishes a tray of an enclosure assembly of the battery pack.

In a further non-limiting embodiment of any of the foregoing battery packs, the retention cradle includes flexible arms that extend from an exterior surface of the plate body.

In a further non-limiting embodiment of any of the foregoing battery packs, the flexible arms establish a channel of the retention cradle.

In a further non-limiting embodiment of any of the foregoing battery packs, the coolant conduit is received in the channel in an interference fit.

In a further non-limiting embodiment of any of the foregoing battery packs, the plate body excludes any internal cooling circuit.

A battery pack according to another exemplary aspect of the present disclosure includes, among other thing, an enclosure assembly, a battery assembly housed within the enclosure assembly, and a heat exchanger plate assembly positioned proximate the battery assembly. The heat exchanger plate assembly includes a plate body and a coolant conduit secured at an exterior surface of the plate body.

In a further non-limiting embodiment of the foregoing battery pack, the battery assembly includes a first grouping of battery cells, and a second battery assembly is laterally spaced from the battery assembly and includes a second grouping of battery cells.

In a further non-limiting embodiment of either of the foregoing battery packs, the battery assembly and the second grouping of battery cells are both received over the heat exchanger plate assembly.

In a further non-limiting embodiment of any of the foregoing battery packs, the heat exchanger plate assembly establishes a tray of the enclosure assembly, and the coolant conduit is outside of an interior of the enclosure assembly.

In a further non-limiting embodiment of any of the foregoing battery packs, the coolant conduit is secured to the plate body using at least one retention cradle.

In a further non-limiting embodiment of any of the foregoing battery packs, the coolant conduit extends along a meandering path inside the enclosure assembly.

In a further non-limiting embodiment of any of the foregoing battery packs, the meandering path is figure eight shaped.

In a further non-limiting embodiment of any of the foregoing battery packs, the coolant conduit includes sections that extend beneath the battery assembly and a second battery assembly.

In a further non-limiting embodiment of any of the foregoing battery packs, the coolant conduit is secured to the plate body and a second plate body of the battery assembly, and is further secured to a third plate body and a fourth plate body of a second battery assembly.

In a further non-limiting embodiment of any of the foregoing battery packs, a thermal interface material is disposed between the battery assembly and the plate body of the heat exchanger plate assembly.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates a powertrain of an electrified vehicle.

FIG. 2 illustrates a battery pack of an electrified vehicle.

FIG. 3 illustrate another exemplary battery pack.

FIG. 4 illustrates an exemplary battery assembly of a battery pack.

FIG. 5 illustrates another exemplary battery assembly of a battery pack.

FIG. 6 illustrates yet another exemplary battery pack.

FIG. 7 illustrates a heat exchanger plate assembly for liquid cooling a battery pack.

FIG. 8 illustrates a plate body of the heat exchanger plate assembly of FIG. 5.

FIG. 9 illustrates a first exemplary routing configuration of a flexible coolant conduit of a heat exchanger plate assembly.

FIG. 10 illustrates a second exemplary routing configuration of a flexible coolant conduit of a heat exchanger plate assembly.

### DETAILED DESCRIPTION

This disclosure details exemplary battery pack designs for use in electrified vehicles. A heat exchanger plate assembly is utilized to thermally manage heat generated by battery cells of a battery pack. In some embodiments, the heat exchanger plate assembly includes a plate body having a snap-fit retention device for retaining a flexible coolant conduit to the plate body. These and other features are discussed in greater detail in the following paragraphs of this detailed description.

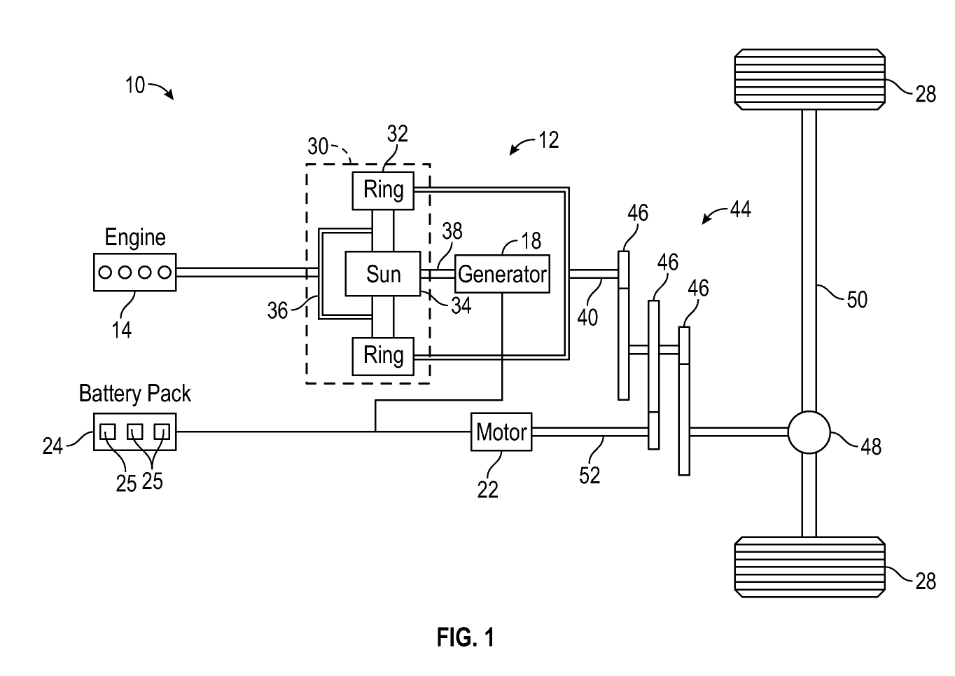

FIG. 1 schematically illustrates a powertrain 10 for an electrified vehicle 12. Although depicted as a hybrid electric vehicle (HEV), it should be understood that the concepts described herein are not limited to HEVs and could extend to other electrified vehicles, including, but not limited to, plug-in hybrid electric vehicles (PHEV's), battery electric vehicles (BEVs), fuel cell vehicles, etc.

In an embodiment, the powertrain 10 is a power-split powertrain system that employs first and second drive systems. The first drive system includes a combination of an engine 14 and a generator 18 (i.e., a first electric machine). The second drive system includes at least a motor 22 (i.e., a second electric machine), the generator 18, and a battery pack 24. In this example, the second drive system is considered an electric drive system of the powertrain 10. The first and second drive systems are each capable of generating torque to drive one or more sets of vehicle drive wheels 28 of the electrified vehicle 12. Although a power-split configuration is depicted in FIG. 1, this disclosure extends to any hybrid or electric vehicle including full hybrids, parallel hybrids, series hybrids, mild hybrids or micro hybrids.

The engine 14, which may be an internal combustion engine, and the generator 18 may be connected through a power transfer unit 30, such as a planetary gear set. Of course, other types of power transfer units, including other gear sets and transmissions, may be used to connect the engine 14 to the generator 18. In a non-limiting embodiment, the power transfer unit 30 is a planetary gear set that includes a ring gear 32, a sun gear 34, and a carrier assembly 36.

The generator 18 can be driven by the engine 14 through the power transfer unit 30 to convert kinetic energy to electrical energy. The generator 18 can alternatively function as a motor to convert electrical energy into kinetic energy, thereby outputting torque to a shaft 38 connected to the power transfer unit 30. Because the generator 18 is operatively connected to the engine 14, the speed of the engine 14 can be controlled by the generator 18.

The ring gear 32 of the power transfer unit 30 may be connected to a shaft 40, which is connected to vehicle drive wheels 28 through a second power transfer unit 44. The second power transfer unit 44 may include a gear set having a plurality of gears 46. Other power transfer units may also be suitable. The gears 46 transfer torque from the engine 14 to a differential 48 to ultimately provide traction to the vehicle drive wheels 28. The differential 48 may include a plurality of gears that enable the transfer of torque to the vehicle drive wheels 28. In a non-limiting embodiment, the second power transfer unit 44 is mechanically coupled to an axle 50 through the differential 48 to distribute torque to the vehicle drive wheels 28.

The motor 22 can also be employed to drive the vehicle drive wheels 28 by outputting torque to a shaft 52 that is also connected to the second power transfer unit 44. In a non-limiting embodiment, the motor 22 and the generator 18 cooperate as part of a regenerative braking system in which both the motor 22 and the generator 18 can be employed as motors to output torque. For example, the motor 22 and the generator 18 can each output electrical power to the battery pack 24.

The battery pack 24 is an exemplary electrified vehicle battery. The battery pack 24 may be a high voltage traction battery that includes a plurality of battery assemblies 25 (i.e., battery arrays or groupings of battery cells) capable of outputting electrical power to operate the motor 22, the generator 18, and/or other electrical loads of the electrified vehicle 12. Other types of energy storage devices and/or output devices could also be used to electrically power the electrified vehicle 12.

In an embodiment, the electrified vehicle 12 has two basic operating modes. The electrified vehicle 12 may operate in an Electric Vehicle (EV) mode where the motor 22 is used (generally without assistance from the engine 14) for vehicle propulsion, thereby depleting the battery pack 24 state of charge up to its maximum allowable discharging rate under certain driving patterns/cycles. The EV mode is an example of a charge depleting mode of operation for the electrified vehicle 12. During EV mode, the state of charge of the battery pack 24 may increase in some circumstances, for example due to a period of regenerative braking. The engine 14 is generally OFF under a default EV mode but could be operated as necessary based on a vehicle system state or as permitted by the operator.

The electrified vehicle 12 may additionally operate in a Hybrid (HEV) mode in which the engine 14 and the motor 22 are both used for vehicle propulsion. The HEV mode is an example of a charge sustaining mode of operation for the electrified vehicle 12. During the HEV mode, the electrified vehicle 12 may reduce the motor 22 propulsion usage in order to maintain the state of charge of the battery pack 24 at a constant or approximately constant level by increasing the engine 14 propulsion. The electrified vehicle 12 may be operated in other operating modes in addition to the EV and HEV modes within the scope of this disclosure.

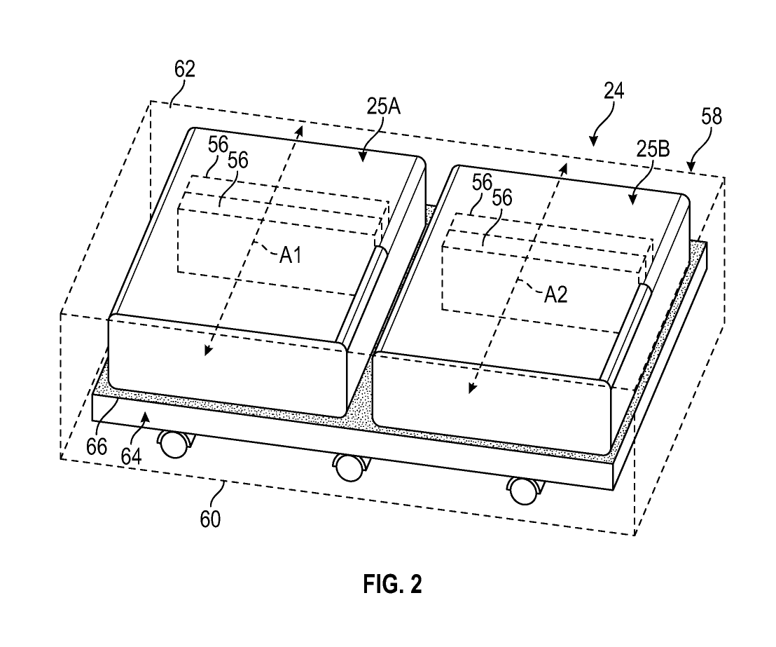

FIG. 2 schematically illustrates a battery pack 24 that can be employed within an electrified vehicle. For example, the battery pack 24 could be part of the powertrain 10 of the electrified vehicle 12 of FIG. 1. FIG. 2 is a perspective view of the battery pack 24, and some external components (e.g., an enclosure assembly 58) are shown in phantom to better illustrate the internal components of the battery pack 24.

The battery pack 24 houses a plurality of battery cells 56, also shown in phantom, that store energy for powering various electrical loads of the electrified vehicle 12. The battery pack 24 could employ any number of battery cells within the scope of this disclosure. Thus, this disclosure is not limited to the exact configuration shown in FIG. 2.

The battery cells 56 may be stacked side-by-side to construct a grouping of battery cells 56, sometimes referred to as a “cell stack” or “cell array.” In an embodiment, the battery cells 56 are prismatic, lithium-ion cells. However, battery cells having other geometries (cylindrical, pouch, etc.), other chemistries (nickel-metal hydride, lead-acid, etc.), or both could alternatively be utilized within the scope of this disclosure.

The battery cells 56, along with any support structures (e.g., array frames, spacers, rails, walls, plates, bindings, etc.), may collectively be referred to as a battery assembly. The battery pack 24 depicted in FIG. 2 includes a first battery assembly 25A and a second battery assembly 25B that is side-by-side with the first battery assembly 25A. Although the battery pack 24 of FIG. 2 is depicted as having a two battery assemblies, the battery pack 24 could include a greater or fewer number of battery assemblies within the scope of this disclosure.

The battery cells 56 of the first battery assembly 25A are distributed along a first longitudinal axis A1, and the battery cells 56 of the second battery assembly 25B are distributed along a second longitudinal axis A2. In an embodiment, the first longitudinal axis A1 is laterally spaced from the second longitudinal axis A2. The first and second battery assemblies 25A, 25B are therefore positioned side-by-side relative to one another in this embodiment.

An enclosure assembly 58 houses each battery assembly 25A, 25B of the battery pack 24. In an embodiment, the enclosure assembly 58 is a sealed enclosure that includes a tray 60 and a cover 62 that is secured to the tray 60 to enclose and seal each battery assembly 25A, 25B of the battery pack 24. In an embodiment, the first and second battery assemblies 25A, 25B are both positioned over the tray 60 of the enclosure assembly 58, and the cover 62 may be received over the first and second battery assemblies 25A, 25B. The enclosure assembly 58 may include any size, shape, and configuration within the scope of this disclosure.

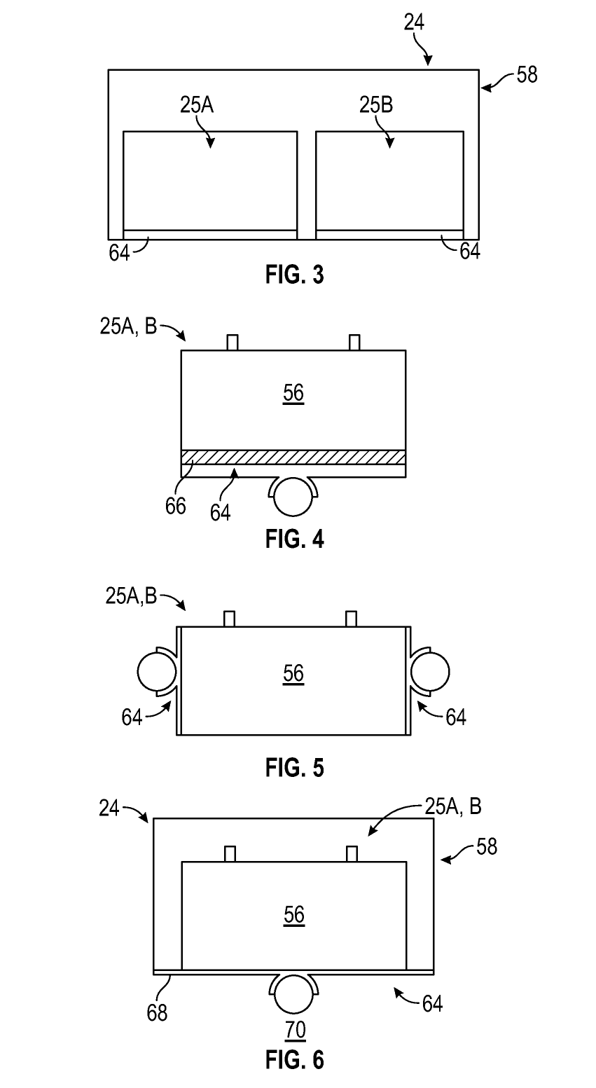

Each battery assembly 25A, 25B of the battery pack 24 may be positioned relative to one or more heat exchanger plate assemblies 64 such that the battery cells 56 are either in direct contact with or in close proximity to at least one heat exchanger plate assembly 64. In an embodiment, the battery assemblies 25A, 25B share a common heat exchanger plate assembly 64 (see, e.g., FIG. 2). Alternatively, each battery assembly 25A, 25B could be positioned relative to its own heat exchanger plate assembly 64 (see, e.g., FIG. 3).

As schematically shown in FIG. 2, a thermal interface material (TIM) 66 may optionally be positioned between the battery assemblies 25A, 25B and the heat exchanger plate assembly 64 such that exposed surfaces of the battery cells 56 are in direct contact with the TIM 66. The TIM 66 maintains thermal contact between the battery cells 56 and the heat exchanger plate assembly 64 and increases the thermal conductivity between these neighboring components during heat transfer events. The TIM 66 may be made of any known thermally conductive material.

In a first embodiment, the heat exchanger plate assembly 64 acts as a base plate of the battery assemblies 25A, 25B (see, e.g., FIG. 4). In a second embodiment, the heat exchanger plate assembly 64 acts as a sidewall of the battery assemblies 25A, 25B, with one heat exchanger plate assembly 64 disposed along each side of the battery assemblies 25A, 25B (see, e.g., FIG. 5). In a third embodiment, the heat exchanger plate assembly 64 acts as the tray of the enclosure assembly 58 of the battery pack 24 (see, e.g., FIG. 6). In such an embodiment, the heat exchanger plate assembly 64 includes at least one exterior surface 68 exposed to an exterior environment 70 (i.e., the environment that surrounds the outside of the battery pack 24).

The heat exchanger plate assembly 64 is configured for thermally managing the battery cells 56 of each battery assembly 25A, 25B. For example, heat may be generated and released by the battery cells 56 during charging operations, discharging operations, extreme ambient conditions, or other conditions. It may be desirable to remove the heat from the battery pack 24 to improve capacity and life of the battery cells 56. The heat exchanger plate assembly 64 is configured to conduct the heat out of the battery cells 56. In other words, the heat exchanger plate assembly 64 acts as a heat sync to remove heat from the heat sources (i.e., the battery cells 56). The heat exchanger plate assembly 64 could alternatively be employed to heat the battery cells 56, such as during extremely cold ambient conditions. Exemplary heat exchanger plate assembly designs for thermally managing the battery cells 56 of the battery pack 24 are further detailed below.

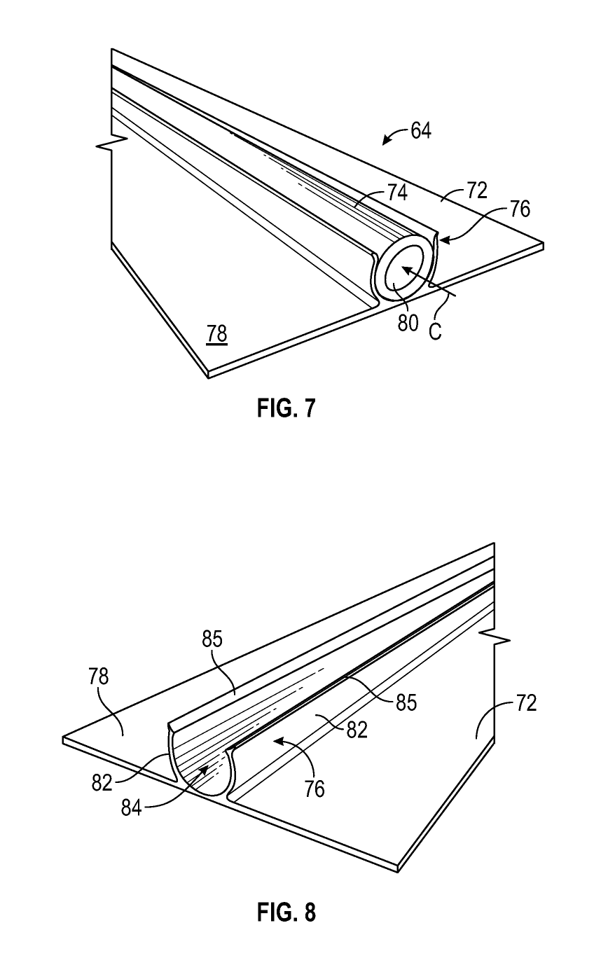

FIG. 7 illustrates a heat exchanger plate assembly 64 according to an embodiment of this disclosure. The heat exchanger plate assembly 64 includes a plate body 72 and a coolant conduit 74 secured relative to the plate body 72 by a retention cradle 76. Although a single coolant conduit 74 and retention cradle 76 are illustrated in FIG. 7, the heat exchanger plate assembly 64 could employ a greater number of conduits and retention devices depending on the cooling requirements of a particular battery pack.

The coolant conduit 74 may be snapped into the retention cradle 76 to assemble the heat exchanger plate assembly 64. In an embodiment, the coolant conduit 74 and the retention cradle 76 are received together to establish an interference fit. Once received in the retention cradle 76, the coolant conduit 74 is in contact with an exterior surface 78 of the plate body 72.

The plate body 72 of the heat exchanger plate assembly 64 may be an extruded part. Other manufacturing techniques are also contemplated within the scope of this disclosure. In another embodiment, the plate body 72 is made of aluminum. Other materials are also suitable for constructing the plate body 72.

The coolant conduit 74 may be a tube, hose, or any other type of conduit and can be made of any sufficiently conductive material. In an embodiment, the coolant conduit 74 is a flexible conduit that can be easily bent and/or manipulated for simple installation within a battery pack. A coolant C may be selectively circulated through a passageway 80 of the coolant conduit 74 to thermally condition the battery cells 56 of the battery pack 24. In an embodiment, the coolant C is a conventional type of coolant mixture such as water mixed with ethylene glycol. However, other coolants, including gases, are also contemplated within the scope of this disclosure. In use, heat from the battery cells 56 is conducted into the plate body 72 and then into the coolant C as the coolant C is communicated through the coolant conduit 74.

Referring now to FIG. 8, the retention cradle 76 may be integrally formed with the plate body 72. Alternatively, the retention cradle 76 could be a separate component that is secured (e.g., welded) to the plate body 72. The retention cradle 76 may extend across an entire length of the plate body 72 or across only a discrete portion of the plate body 72.

In an embodiment, the retention cradle 76 includes flexible arms 82 that protrude outwardly from the exterior surface 78 of the plate body 72. The flexible arms 82 establish a channel 84 for receiving the coolant conduit 74. In an embodiment, the channel 84 is C-shaped.

During assembly of the heat exchanger plate assembly 64, the flexible arms 82 are configured to flex away from one another as the coolant conduit 74 is pushed into contact with curved flanges 85 of the flexible arms 82. As the coolant conduit 74 is moved further into the channel 84, the flexible arms 82 flex back toward one another until they contact the coolant conduit 74 to establish the snap fit or interference fit connection between the two components. The mounting location of the coolant conduit 74/retention cradle 76 is design specific and can be specifically tuned to address the thermal requirements of a given battery pack. For example, the retention cradle 76 can be positioned at the axial location of the plate body 72 that contacts the areas of the battery cells 56 most susceptible to high heat loads.

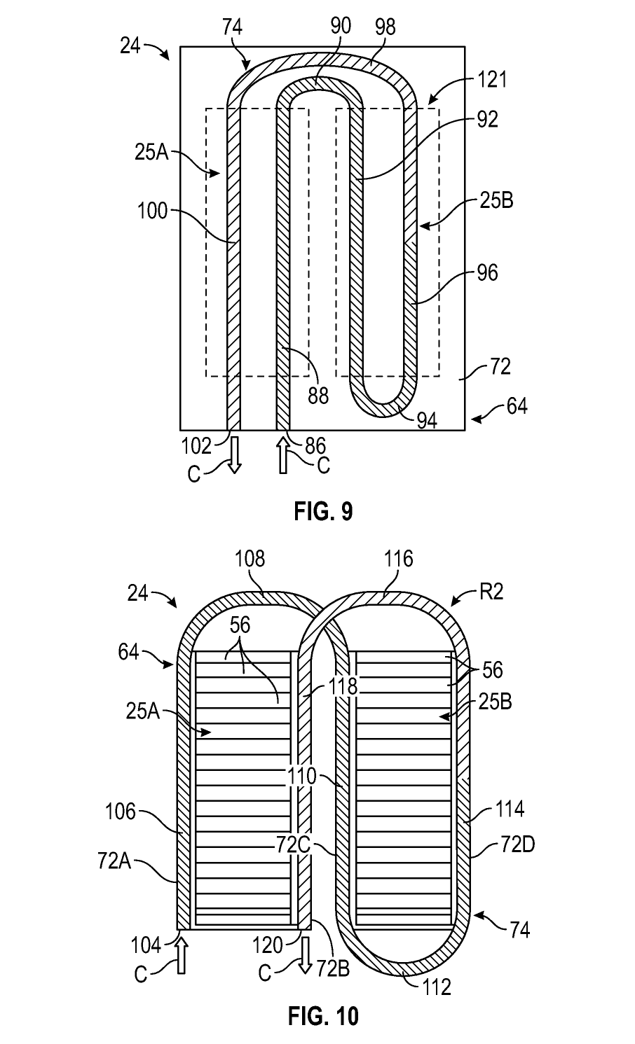

FIG. 9, with continued reference to FIGS. 2-8, illustrates a first exemplary routing configuration R1 of a coolant conduit 74 of a heat exchanger plate assembly 64. In this embodiment, the coolant conduit 74 is a single, flexible tube that is routed along the plate body 72 of the heat exchanger plate assembly 64 for thermally managing first and second battery assemblies 25A, 25B of a battery pack 24. Although not shown in FIG. 9 for simplification, one or more retention cradles 76 can be secured to the plate body 72 for affixing the coolant conduit 74 to the plate body 72.

In an embodiment, the coolant conduit 74 includes an inlet 86 for receiving the coolant C, a first linear section 88 connected to the plate body 72 and extending beneath the first battery assembly 25A, a first curved section 90 that connects between the first linear section 88 and a second linear section 92 that is connected to the plate body 72 and extends beneath the second battery assembly 25B, a second curved section 94 that connects between the second linear section 92 and a third linear section 96 that is connected to the plate body 72 and extends beneath the second battery assembly 25B, a third curved section 98 that connects between the third linear section 96 and a fourth linear section 100 that is connected to the plate body 72 and extends beneath the first battery assembly 25A, and an outlet 102 for the coolant C to exit the coolant conduit 74. In use, the coolant C enters the inlet 86 and then circulates along a meandering path through the first linear section 88, the first curved section 90, the second linear section 92, the second curved section 94, the third linear section 96, the third curved section 98, and the fourth linear section 100 before exiting the outlet 102 in order to dissipate heat that has been conducted into the plate body from battery cells 56 of the first and second battery assemblies 25A, 25B. The coolant C exiting through the outlet 102 is warmer than the coolant C entering the inlet 86.

FIG. 10, with continued reference to FIGS. 2-8, illustrates a second exemplary routing configuration R2 of a coolant conduit 74 of a heat exchanger plate assembly 64. In this embodiment, the coolant conduit 74 is a single, flexible tube that is routed along multiple plate bodies 72A-72D for thermally managing first and second battery assemblies 25A, 25B of a battery pack 24. Each battery assembly 25A, 25B of this embodiment includes two plate bodies 72 that double as side plates of the battery assemblies 25A, 25B. Although not shown in FIG. 10 for simplification, one or more retention cradles 76 can be secured to each plate body 72 for affixing the coolant conduit 74 to the plate bodies 72.

In an embodiment, the coolant conduit 74 includes an inlet 104 for receiving the coolant C, a first linear section 106 connected to the plate body 72A of the first battery assembly 25A, a first curved section 108 that connects between the first linear section 106 and a second linear section 110 that is connected to the plate body 72C of the second battery assembly 25B, a second curved section 112 that connects between the second linear section 110 and a third linear section 114 that is connected to the plate body 72D of the second battery assembly 25B, a third curved section 116 that connects between the third linear section 114 and a fourth linear section 118 that is connected to the plate body 72B of the first battery assembly 25A, and an outlet 120 for the coolant C to exit from the coolant conduit 74.

In use, the coolant C enters the inlet 104 and then circulates along a meandering, “figure eight” shaped path through the first linear section 106, the first curved section 108, the second linear section 110, the second curved section 112, the third linear section 114, the third curved section 116, and the fourth linear section 118 before exiting the outlet 120 in order to dissipate heat that has been conducted into the plate bodies 72A-72D from battery cells 56 of the first and second battery assemblies 25A, 25B.

The heat exchanger plate assemblies of this disclosure include snap-fitting, flexible coolant conduits that eliminate the need to form internal coolant cavities inside the plate bodies of the heat exchanger plate assemblies. The concepts presented in this disclosure offer a low-cost alternative with a much simpler design as compared to existing cold plates. The exemplary heat exchanger assemblies may be integrated into the array and/or pack structure to potentially provide cell retention, compression, support, and enclosure functions in addition to cooling. This multifunction potential can reduce cost and weight of the battery pack.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A battery pack, comprising:
a heat exchanger plate assembly including:
a plate body;
a retention cradle protruding outwardly from the plate body; and
a coolant conduit secured to the plate body by the retention device.

2. The battery pack as recited in claim 1, wherein the plate body is an extruded, aluminum plate body.

3. The battery pack as recited in claim 1, wherein the coolant conduit is a flexible tube.

4. The battery pack as recited in claim 1, wherein the heat exchanger plate assembly is a base of a battery assembly of the battery pack.

5. The battery pack as recited in claim 1, wherein the heat exchanger plate assembly is a side wall of a battery assembly of the battery pack.

6. The battery pack as recited in claim 1, wherein the heat exchanger plate assembly establishes a tray of an enclosure assembly of the battery pack.

7. The battery pack as recited in claim 1, wherein the retention cradle includes flexible arms that extend from an exterior surface of the plate body.

8. The battery pack as recited in claim 7, wherein the flexible arms establish a channel of the retention cradle.

9. The battery pack as recited in claim 8, wherein the coolant conduit is received in the channel in an interference fit.

10. The battery pack as recited in claim 1, wherein the plate body excludes any internal cooling circuit.

11. A battery pack, comprising:
an enclosure assembly;
a battery assembly housed within the enclosure assembly; and
a heat exchanger plate assembly positioned proximate the battery assembly, wherein the heat exchanger plate assembly includes a plate body and a coolant conduit secured at an exterior surface of the plate body.

12. The battery pack as recited in claim 11, wherein the battery assembly includes a first grouping of battery cells, and comprising a second battery assembly laterally spaced from the battery assembly and including a second grouping of battery cells.

13. The battery pack as recited in claim 12, wherein the battery assembly and the second grouping of battery cells are both received over the heat exchanger plate assembly.

14. The battery pack as recited in claim 11, wherein the heat exchanger plate assembly establishes a tray of the enclosure assembly, and the coolant conduit is outside of an interior of the enclosure assembly.

15. The battery pack as recited in claim 11, wherein the coolant conduit is secured to the plate body using at least one retention cradle.

16. The battery pack as recited in claim 11, wherein the coolant conduit extends along a meandering path inside the enclosure assembly.

17. The battery pack as recited in claim 16, wherein the meandering path is figure eight shaped.

18. The battery pack as recited in claim 11, wherein the coolant conduit includes sections that extend beneath the battery assembly and a second battery assembly.

19. The battery pack as recited in claim 11, wherein the coolant conduit is secured to the plate body and a second plate body of the battery assembly, and is further secured to a third plate body and a fourth plate body of a second battery assembly.

20. The battery pack as recited in claim 11, comprising a thermal interface material disposed between the battery assembly and the plate body of the heat exchanger plate assembly.
